(19) United States
(12) Patent Application Publication
(10) Pub. No.: US 2009/0128328 A1
(43) Pub. Date: May 21, 2009

(54) Automatic monitoring system with a security system

(76) Inventor: HSIN-FA FAN, Taoyuan County (TW)

Correspondence Address: MICHAEL LIN, 5F 79 Roosevelt Rd. Sec. 2, TAIPEI, 106, TW

(21) Appl. No.: 11/943,594

(22) Filed: Nov. 21, 2007

(51) Int. Cl. G08B 13/00; H04N 7/18

(52) U.S. Cl. 340/541; 348/152; 348/E07.085

(57) ABSTRACT

The invention is related to a security system of an automatic monitoring system that is used to guard the automatic monitoring system from theft. The security system uses a sensing device to detect the movement or vibration of the monitoring system and produces a sense signal that will be processed by an information processing device to produce and send out a warning signal to guard the automatic monitoring system against theft and track the position after being moved.

### BACKGROUND OF THE INVENTION

1. Field of the Invention

The invention is related to a security system, especially one with automatic monitoring system.

2. Description of the Prior Art

With technological advancement and living quality improvement, people are demanding convenience as well as environmental quality and life security. Extensive automatic monitoring on environment requires various monitoring systems. When nobody is watching due to issues in safety and traffic difficulty, the expensive monitoring equipment needs a good security system to guard property loss and keep the monitoring task in a right way. Recently, for environmental detection in a temporary situation there is already development of many mobile monitoring systems, which after connection with vehicles can be immediately carried to the place that needs monitoring. After installation the installers need to leave immediately due to hazards in the monitored environment. Thus, a sound security system is necessary. In fact, after the monitoring system is installed, rotating, moving, or inclination due to interference could cause malfunction for the equipment or mistargeting, leading to failure to satisfy the requirement of monitoring.

Present security or anti-theft system is mainly to provide alarming at break-in or theft, but fails to know whether rotating, inclination or moving has happened to the monitoring system. Therefore, it is necessary to have an innovative security system with a device to sense the for the movement of the monitoring systems that can determine whether the monitoring system is moved, stolen or damaged. Recently, the tri-axis accelerometer technology has matured and commercialized. It has been applied to the development of robots to quickly provide three-dimensional acceleration g value and shift. In either a planar direction or perpendicular direction, it can instantly measure position shift. For example, when the height change is due to mobile monitoring system falling down to valley due to landslide, it can measure the falling depth. Tri-axis accelerometer can measure shift and also work for positioning without barrier effect. This is an advantage that Global Positioning System (GPS) does not have. It can locate the position after being moved more accurately. It also works for detection of vibration and shaking. Whether the automatic monitoring system is stricken, shaken or damaged can be detected. It can combine inclination and shift detection to find out whether the monitoring equipment meets the requirements of tasks. Besides, environmental monitoring with video monitoring is getting popular. Digital monitoring in video processing technology can detect the movement of the interesting object in the image. When the object becomes larger than a certain size and moves closer up to a certain level, it can be considered as somebody is approaching intentionally. Through integration of tri-axis accelerometer, video monitoring function, GPS, the instant transmission by cable and wireless communication network, like General Packet Radio Services (GPRS), 3G or Worldwide Interoperability for Microwave Access (WiMAX) can effectively track the real-time position of the position after being moved and facilitate seeking the automatic monitoring system. This is a solution for the above issues.

### SUMMARY OF THE INVENTION

One objective for the invention is to provide a security system for automatic monitoring system. Therefore, it is through a sensing device to sense the rotating, movement, inclination or vibration of the automatic monitoring system to know it is working in a right way and doesn't lose any function caused by motion and damage.

Another objective for the invention is to provide a security system for automatic monitoring system. Therefore, it is through a video monitoring device to detect a moving object and produce video data and a sense signal. It provides real-time video data and guards automatic monitoring system from invasion, burglary or damage.

The security system for the automatic monitoring system in the invention is to guard motion, theft or damage. The security system comprises a sensing device, a video monitoring device and an information processing device. The sensing device detects the movement status and vibration status for the automatic monitoring system and produces a sense signal. The processing information device receives the sense signal, and the produces an in-situ warning signal to guard the theft, and instantly sends out the signal to control center for monitoring the incident and taking appropriate measures in early time.

For example, if burglary is found, alarm will be activated with broadcasting of warning. Also through connection to security organization or police, it will immediately stop the burglary activity.

### BRIEF DESCRIPTION OF THE DRAWINGS

The present invention will be apparent to those skilled in the art by reading the following of a preferred embodiment thereof, with reference to the accompanying drawings, in which:

FIG. 1 is a block diagram for a preferred embodiment of the invention;

FIG. 2 is a block diagram for another preferred embodiment of the invention; and

FIG. 3 is a block diagram for another preferred embodiment of the invention.

### DETAILED DESCRIPTION OF THE PREFERRED EMBODIMENT

To further explain the structural features and performance for the invention, preferred embodiments with detailed description will be provided in the following.

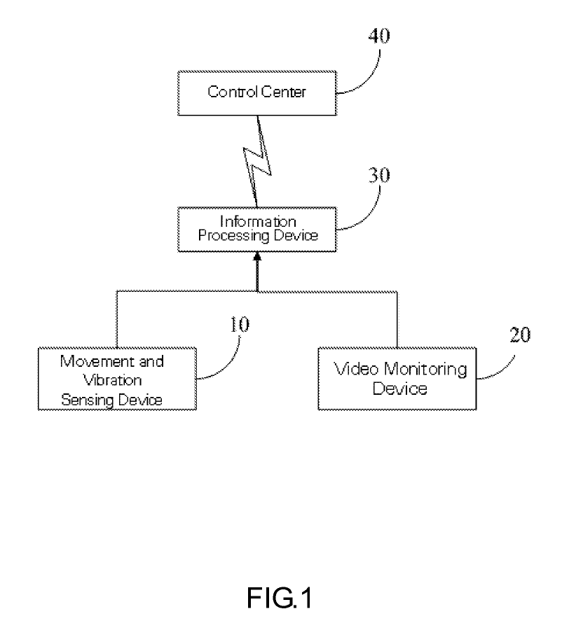

Please refer to FIG. 1 for the block diagram for a preferred embodiment in the invention. As shown in the figure, the security system of the automatic monitoring system in the invention is mainly used to guard theft. The security system comprises one video sensing device 10, one video monitoring device 20, one information device 30 and one control center 40.

The sensing device 10 of the security system senses the movement status or vibration status of the monitoring system, and then produces and outputs a sense signal to a processing information device 30. After the information-processing device 30 receives the sense signal, it produces and sends out a warning signal to guard the automatic monitoring system from damage, motion or loss due to burglary. The sensing device 10 can be a tri-axis accelerometer that produces a sense signal based on the detected movement or vibration of the automatic monitoring system, i.e. it produces a sense signal based on the detecting of movement, rotation angle or vibration status for the automatic monitoring system. Among these, vibration status is a rotation angle or an angular velocity, and movement status is a horizontal shift or a vertical shift. Further, when the movement status or vibration status detected by the sensing device 10 is larger than a threshold the information-processing device 30 will produce and send out a warning signal to control center 40 to warn the monitoring personnel to notice the current status of the automatic monitoring system. Further, when the security system senses theft or burglary for the monitoring system, the information-processing device 30 will send out alarm to the control center and demand the video monitoring device 20 to increase video capture frequency and transmit the video to the control center 40 for the control center personnel to have instant information of the environmental situation around the monitoring system.

The video monitoring device 20 produces video data on the monitored object or environmental situation and instantly sends the data to the information-processing device 30. The information-processing device 30 links to the video monitoring device 20 to receive video data and outputs the data to the control center 40 for control center 40 personnel to have the environmental status around the monitoring system. Further, the video monitoring device 20 can further track the moving object and determine whether it is approaching the monitoring system. When the approaching object has its image up to a certain threshold, the video monitoring device 20 is activated to record and send out alarm.

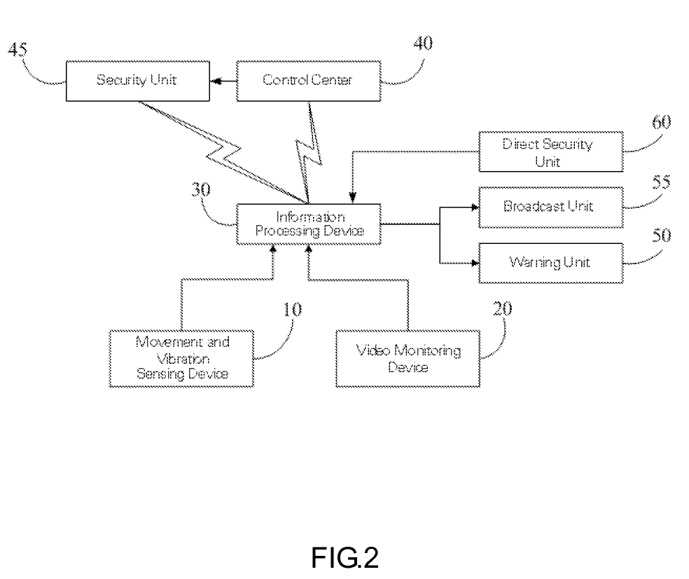

Please refer to FIG. 2 for the block diagram of another preferred embodiment in the invention. As shown in the figure, the difference from the embodiment in FIG. 1 is that this embodiment further comprises one security organization 45, one warning unit 50, one broadcast unit 55 and one direct security unit 60. After the control center 40 receives the warning from the information-processing device 30, the monitoring personnel will notify the security organization 45 if necessary, and respond to the warning. The security organization 45 can be private security company or police to take charge of the security task for the monitoring system. If the control center 40 has no response within a certain time, the information-processing device 30 will automatically notify the security organization 45.

The warning unit 50 links the information-processing device 30. When the information-processing device 30 receives the sense signal from the sensing device 10 or the video monitoring device 20, it can produce a warning signal and sends it to the warning unit 50. The warning unit 50 can be a warning light, like speakers, LCD screen or beepers. For example, when the sensing device 10 senses that the monitoring system is shifted or damaged, the information-processing device 30 will send the warning signal to the warning unit 50 that will activate the warning light or broadcasting to stop the invaders. The broadcast unit 55 links to the information-processing device 30, and receives the message and audio from the control center to produce broadcasting necessary on site. The broadcast unit 55 is a broadcasting device (like speaker or LCD screen). For example, when the information-processing device 30 receives the sense signal from the sensing device 10, it can produce a warning signal and send it out to the control center 40, where the monitoring personnel will immediately monitor the status of the incident through the video monitoring device 20. If unknown person is found in the incident on the video, a broadcasting signal will be sent to the broadcast unit 55, and broadcasting voice will go out to ask the person to leave immediately. The direct security unit 60 can be a direct independent anti-theft device (like common human infrared sensor in market, anti-theft device based on damaged caused vibration and sound). The produced alarm will be sent to the information-processing device 30. Through the information-processing device 30, the alarm is further sent to the control center 40 to alert the monitoring personnel that some object is approaching the monitoring system and responsive measures shall start.

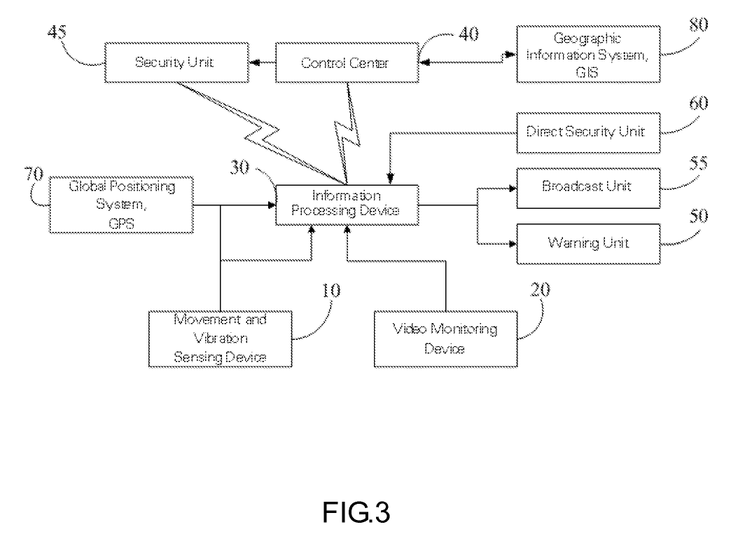

Please refer to FIG. 3 for the block diagram of another embodiment of the invention. As shown in the figure, the difference from the previous embodiment is that this embodiment further has a Global Positioning System, GPS 70 and a Geographic Information System, GIS 80 that link to the information-processing device 30 and the control center 40 respectively. The GPS 70 receives satellite data and sends it to the information-processing device 30 to provide current coordinate and send the coordinate to the control center 40. Further, the GIS 80 stores geographic data that the control center 40 will use with the coordinate from the information-processing device 30 to learn the position of the monitoring system and display it on the digital map in the control center 40. So the monitoring personnel will know the location of the monitoring system. When the monitoring system is moved due to unknown reason, the personnel can use GPS 70 and GIS 80 to learn its location and further track back the location of the automatic monitoring system. Further, since the sensing device 10 is a tri-axis accelerometer that help to get three-dimensional motion data. The information-processing device 30 can incorporate the motion data and GPS data. When the GPS 70 fails to receive satellite signal, it can add the motion data to the designated position in the end and calculate the location. Not only the height shift data generated by the sensing device 10 helps determine whether the monitoring system falls down to valley, but also the control center 40 tracks the falling depth as the basis for recovering the monitoring system.

In summary, the security system for the automatic monitoring system in the invention produces a sense signal based on the movement status or vibration status for a automatic monitoring system, and then sends it to information-processing device, which will send out a warning signal to alert the control center and guard against losing of function, shifting and damage.

The above description is only one preferred embodiment of the invention, but not to limit the scope of the invention. Equivalent changes and modifications in shape, structure, features and spirits shall be within the scope of the invention.

What is claimed is:

1. A security system used to protect a monitoring system, comprising:
a sensing device, sensing the shifting status or vibration status of the monitoring system, and producing and sending out a sense signal; and
an information device, based on the generated sense signal, producing a warning signal and sending out the warning signal.

2. As described in claim 1 for a security system, the sensing device is a tri-axis accelerometer.

3. As described in claim 1 for a security system, the shifting status is a horizontal shift or a vertical shift.

4. As described in claim 1 for a security system, the vibration status is a rotation angle or an angular velocity.

5. As described in claim 1 for a security system, when the shifting status or vibration status of the monitoring system detected by the sensing device is larger than a threshold, it produces a sense signal.

6. As described in claim 1 for a security system, when the sense signal received by the information device is larger than a threshold, it produces a warning signal.

7. As described in claim 1 for a security system, it further comprises a warning unit to receive the warning signal from the information device and send it out later.

8. As described in claim 1 for a security system, it further comprises a direct security unit to produce a sense signal when it detects an approaching object, and sends it to the information device that produces a warning signal based on the sense signal from the information device.

9. As described in claim 8 for a security system, the detector is an infrared device or a supersonic device.

10. As described in claim 1 for a security system, the monitoring system further comprises a video monitoring device to monitor the object status or environmental status, and then produces video data and sends it out to the information device.

11. As described in claim 10 for a security system, the video monitoring device further tracks the monitored object and produces its video data.

12. As described in claim 10 for a security system, the monitoring system further comprises a control center to receive video data, and to monitor the object by the video monitoring device.

13. As described in claim 12 for a security system, the information device, based on the sense signal, determines the frequency for the video signal to the control center.

14. As described in claim 12 for a security system, it further comprises a broadcast unit to receive a broadcasting signal from the information device and the control center to broadcast the warning.

15. As described in claim 12 for a security system, it further comprises a Geographic Information System to store geographic data that will be used by the control center to locate the monitoring system.

16. As described in claim 1 for a security system, the monitoring system further comprises a control center to receive the warning signal from the information device to learn the burglary at the monitoring system.

17. As described in claim 16 for a security system, it further comprises a broadcast unit to receive the broadcast signal from the information device and the control center to broadcast warning.

18. As described in claim 16 for a security system, it further comprises a Geographic Information System to store geographic data for the control center to locate the monitoring system.

19. As described in claim 1 for a security system, it further comprises a GPS unit to receive satellite data and send it to the information device to calculate the coordinate of the monitoring system.

20. As described in claim 1 for a security system, it further comprises a security system that links to an information device and receives the warning signal from the information device, so it will notify the security personnel of the alert status of the monitoring system.
